(19) United States
(12) Patent Application Publication
(10) Pub. No.: US 2009/0272448 A1
(43) Pub. Date: Nov. 5, 2009

(54) VALVE OF GAS STOVE

(75) Inventors: Chin-Ying HUANG, Taichung (TW); Chung-Sheng Yen, Taichung County (TW); Hsin-Ming Huang, Taichung (TW)

Correspondence Address: BROWDY AND NEIMARK, P.L.L.C.;624 NINTH STREET, NW, SUITE 300, WASHINGTON, DC, 20001-5303, US

(73) Assignee: GRAND MATE CO., LTD., Taichung (TW)

(21) Appl. No.: 12/131,492

(22) Filed: Jun. 2, 2008

(30) Foreign Application Priority Data
Apr. 30, 2008 (TW) 97207499

(51) Int. Cl. F16K 11/22

(52) U.S. Cl. 137/883

(57) ABSTRACT

A valve of a gas stove includes a valve member and a first sealing member. The valve member is an integral body having a left tube, a right tube, and a connection tube between the left tube and the right tube in a single member. The valve member further has a gas channel therein extended from the left tube, the connection tube to the right tube in sequence and a first bore on the left tube to be communicated with the gas channel. The connection tube has an inlet to be connected to an external gas supply. The first sealing member may be moved to seal the first bore of the gas channel. The present invention has many advantages including strong structure, high precision, and easy for fabrication and assembly.

### BACKGROUND OF THE INVENTION

1. Field of the Invention

The present invention relates generally to a gas stove and, more particularly, to a valve of a gas stove.

2. Description of the Related Art

Typically, a conventional gas stove has a valve between a burner and a gas tube to control the gas flow. FIG. 1 shows a valve 1 of a conventional gas stove, which is a two-piece member including a left tube 2 and a right tube 3. The left tube 2 has a long transverse tube 4, which has an input tube 4a, on an inner side thereof. The right tube 3 has a short transverse tube 5, which is connected to the long transverse tube 4 by screwing, on an inner side thereof. The left and right tubes 2, 3 are connected together that gas may flow to the left tube 2 or the right tube 3 from the input tube 4a.

Such valve, however, connection by screwing, has the following drawbacks. The left and right tube 2, 3 have their individual tolerances that the angle therebetween is hard to control when they are screwed together, such that the valve 1 cannot has a well connection to the gas stove. In addition, when the valve 1 is impacted by an external force, the left and right tube 2, 3 might be loose that will cause gas leakage.

To fix aforesaid drawbacks, Taiwan Patent no. 165,718 discloses a valve that is constructed from a switch member and a barrel member. The switch member is made by casting having the left and right tube on a single member that will make the switch member having a strong structure and a high precision. The switch member, however, has a tunnel on a top thereof, in which a complex control assembly is provided to seal the barrel member. Such switch member is hard to fabricate and assemble. For these reason, the present inventor, according my experience in fabrication of gas stove, has completed the present invention.

### SUMMARY OF THE INVENTION

The primary objective of the present invention is to provide a valve of a gas stove, which has many functions including strong structure, high precision, and easy for fabrication and assembly.

To achieve the objective of the present invention, a valve of a gas stove includes a valve member and a first sealing member. The valve member is an integral body having a left tube, a right tube, and a connection tube between the left tube and the right tube in a single member. The valve member further has a gas channel therein extended from the left tube, the connection tube to the right tube in sequence and a first bore on the left tube to be communicated with the gas channel. The connection tube has an inlet to be connected to an external gas supply. The first sealing member may be moved to seal the first bore of the gas channel. The present invention has many advantages including strong structure, high precision, and easy for fabrication and assembly.

### BRIEF DESCRIPTION OF THE DRAWINGS

FIG. 1 is an exploded view of the conventional valve of the gas stove;

FIG. 2 is an exploded view of a first preferred embodiment of the present invention;

FIG. 3 is a sectional view of the first preferred embodiment of the present invention;

FIG. 4 is a perspective view of the first preferred embodiment of the present invention; and

FIG. 5 is a sectional view of a second preferred embodiment of the present invention.

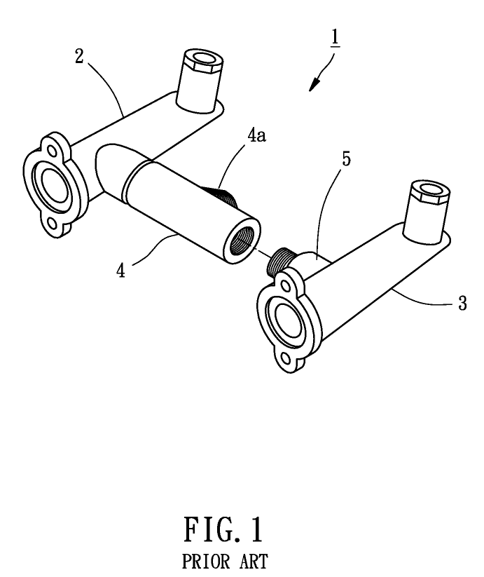

### DETAILED DESCRIPTION OF THE INVENTION

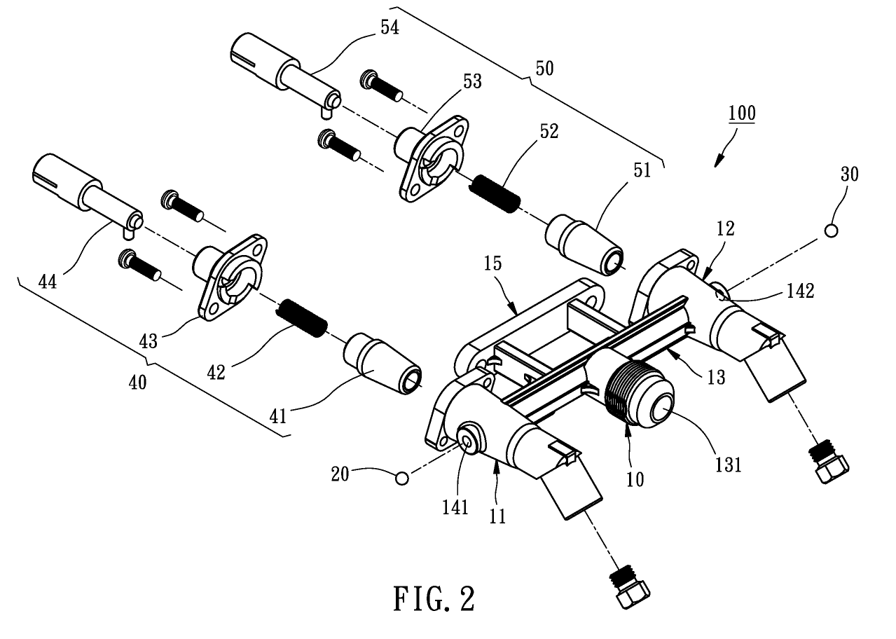

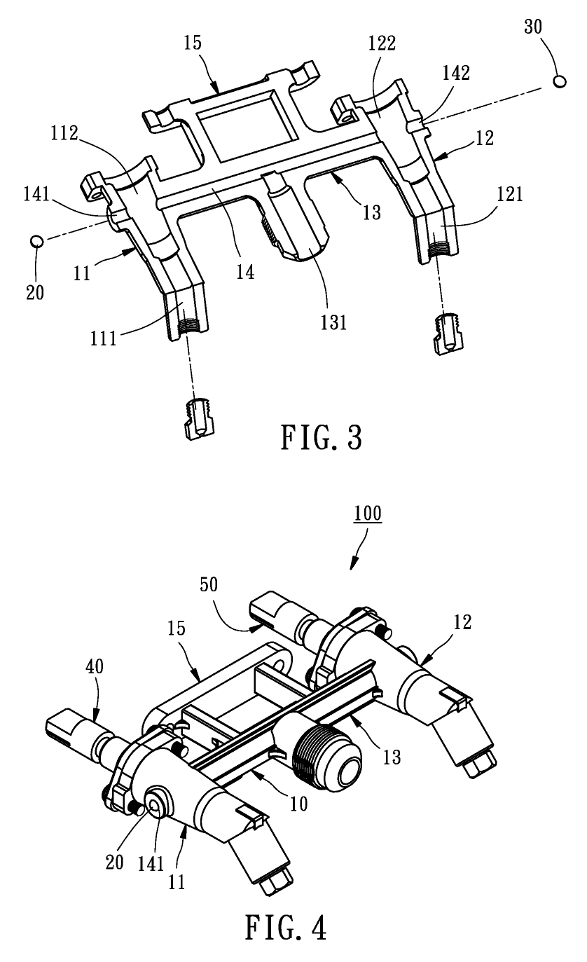

As shown in FIGS. 2 to 4, a valve 100 of a gas stove includes a valve member 10, a first sealing member 20, a second sealing member 30, and two switches 40 and 50.

The valve member 10 is an integral body and made by casting including a left tube 11, a right tube 12, and a connection tube 13 between the left tube 11 and the right tube 12. The left and right tube 11, 12 respectively has an outlet 111, 121 and a bore 112, 122. The valve member 10 has a gas channel 14 from the left tube 11, the connection tube 13 and the right tube 12. The gas channel 14 has opposite ends open on the left and right tubes, defining the open ends as a first bore 141 on the left tube 11 and a second bore 142 on the right tube 12. The connection tube 13 has an inlet 131 to flow gas from a gas supply to the gas channel 14. The valve member 10 further has a frame 15, which is a portion of the integral body also, beside the connection tube 13 to secure the valve member 10 to the gas stove (not shown).

The first and second sealing members 10, 30 are two metal balls, each of which has a diameter greater than that of the first bore 141 and the second bore 142. The first and second sealing members 10, 30 may be forced toward the first bore 141 and the second bore 14 respectively to seal the gas channel 14. It has to be mentioned that the first and second sealing members 10, 30 may be any aspect other than the balls as long as they can seal the first bore 141 and the second bore 14.

The switches 40, 50, each of which include a plug 41, 51, a spring 42, 52, a lid 43, 53, and a shaft 44, 54, are inserted into bores 112, 122 of the left and right tubes 11, 12 respectively. The shafts 44, 54 are turned to move the plugs 41, 51 respectively that may control the gas flow in the tubes 11, 12. The switches 40, 50 are conventional devices that readers may find the detail of the switch in relative documents so we do not describe the detail here.

In conclusion, the left, right, and connection tubes 11, 12, 13 are made in an integral body that the valve 100 of the present invention is very strong to fix the drawback of the conventional two-piece valve 1 having the left and right tubes 2, 3 screwed together that the valve 100 of the present invention has a high precision and quality. In addition, the present invention provides the sealing members 20, 30 installed in the gas channel 14 to seal the first and second bores 141, 142 that the present invention, comparing to the conventional valve 1, may have the advantages of easy for fabrication and assembly, and lower cost.

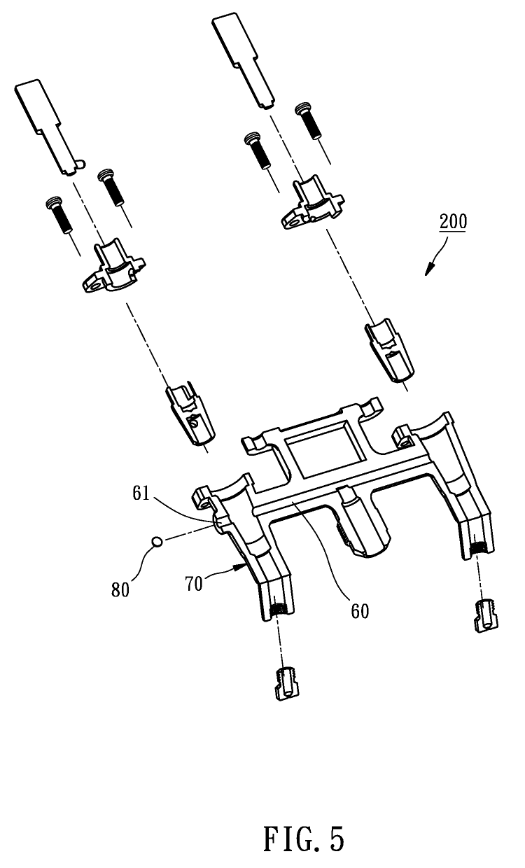

In addition, FIG. 5 shows a valve 200 of a second preferred embodiment of the present invention, which is similar to the valve 100 of the first preferred embodiment, except that the valve 200 includes a gas channel 60 having a first bore 61 on a left tube 70 only, which means it only need a ball, defined as a first sealing member 80, having a diameter greater than that of the first bore 61 to seal it. The valve 200 of a second preferred embodiment of the present invention has the advantage of easy for fabrication and assembly as well.

Although the particular embodiments of the invention has been described in detail for purposes of illustration, various modifications and enhancements may be made without departing from the spirit and scope of the invention. Accordingly, the invention is not to be limited except as by the appended claims.

What is claimed is:

1. A valve of a gas stove, comprising:
a valve member, which is an integral body having a left tube, a right tube, a connection tube between the left tube and the right tube, a gas channel therein extended from the left tube, the connection tube to the right tube in sequence, wherein the left tube has a first bore communicated with the gas channel, and the connection tube has an inlet to be connected to an external gas supply; and
a first sealing member to be moved to seal the first bore of the gas channel.

2. The valve of the gas stove as claimed in claim 1, wherein the first sealing member is a ball to be squeezed in the first bare.

3. The valve of the gas stove as claimed in claim 2, wherein the ball has a diameter greater than that of the first bore.

4. The valve of the gas stove as claimed in claim 1, further comprising a second sealing member, wherein the valve member further has a second bore on the right tube to be communicated with the gas channel, and the second sealing member is moved to seal the second bore of the gas channel.

5. The valve of the gas stove as claimed in claim 4, wherein the second sealing member is a ball to be squeezed in the second bare.

6. The valve of the gas stove as claimed in claim 5, wherein the ball has a diameter greater than that of the second bore.

7. The valve of the gas stove as claimed in claim 1, wherein the valve member further includes a frame, which is a portion of the integral body of the valve member also, beside the connection tube.

8. The valve of the gas stove as claimed in claim 1, further comprising two switches inserted into the left tube and the right tube respectively to control a gas flow in the gas channel.
